(19) United States
(12) Patent Application Publication
(10) Pub. No.: US 2026/0337320 A1
(43) Pub. Date: Oct. 29, 2026

(54) METHOD FOR PRODUCING A COPOLYMER PROCEEDING FROM AT LEAST ONE AROMATIC VINYL COMPOUND

(71) Applicant: INEOS STYROLUTION GROUP GMBH, Frankfurt am Main (DE)

(72) Inventors: Wolfgang FISCHER, Heidelberg (DE); Peter ITTEMANN, Dannstadt-Schauernheim (DE); Norbert NIESSNER, Friedelsheim (DE); Maren WISSING, Muenster (DE)

(21) Appl. No.: 19/115,999

(22) PCT Filed: Sep. 27, 2023
(86) PCT No.: PCT/EP2023/076772

§ 371 Date: Mar. 27, 2025

(30) Foreign Application Priority Data
Sep. 29, 2022 (EP) 22198792.8

(51) Int. Cl. C08F 220/44; C08F 2/06; C08F 6/10; C08F 220/10

(52) U.S. Cl. CPC C08F 220/44; C08F 2/06; C08F 6/10; C08F 220/10

(57) ABSTRACT

The invention relates to a method for producing a copolymer (CP) proceeding from at least one aromatic vinyl compound (A), in particular styrene and/or alpha-methylstyrene, and at least one further monomer (M) from the group consisting of acrylonitrile and methacrylate, the method comprising the following steps: a) polymerisation, b) separation of volatile components, wherein a vapour flow (B) is obtained, c) condensation of at least parts of the vapour flow (B), wherein a first condensate (KS1) and/or a second condensate (KS2) are/is recycled. The invention further relates to a device for performing the method.

The invention relates to a process for producing a copolymer proceeding from at least one aromatic compound, particularly styrene and/or alpha-methylstyrene, and at least one further monomer from the group consisting of acrylonitrile and methacrylate, wherein the process comprises polymerization of the at least one aromatic vinyl compound and the at least one further monomer in at least one reactor in the presence of at least one organic solvent, removal of volatile components to obtain a vapor stream and condensation of at least portions of the vapor stream. The invention also relates to an apparatus for performing the process.

In process engineering, the term vapor describes volatile, gaseous products that are formed in chemical reactions, and in the distilling of liquid mixtures, evaporation, degassing or drying. Vapors may comprise, as volatile components, for example, aromatic vinyl monomers such as styrene or alpha-methylstyrene, vinyl cyanide monomers such as acrylonitrile, methacrylate monomers such as methyl methacrylate MMA and/or organic solvents such as ethylbenzene, but also water vapor, particularly in small amounts.

In the process of the invention, several steps of condensing of the volatile components removed are effected using heat exchangers such as condensers for example. It is possible here to reduce the amount of monomers discharged from the process, such as styrene, alpha-methylstyrene, methyl methacrylate and/or organic solvent such as ethylbenzene.

The copolymers obtained, for example styrene-acrylonitrile copolymers (SAN copolymers), particularly alpha-methylstyrene-acrylonitrile copolymers (AMSAN copolymers) and/or styrene-methyl methacrylate copolymers (SMMA copolymers), have excellent formability, stiffness and durability, and retain these even under weathering. The copolymers can be used in various sectors including the manufacture of automobiles, computers, printers, copiers, domestic appliances, audio systems and electrical components.

A copolymer of an aromatic vinyl compound and a vinyl cyanide compound and/or methacrylate is typically prepared by reaction of the monomers in an organic solvent. The polymerization product at first contains unconverted monomers and organic solvents, which must preferably be removed in an environmentally benign manner. The copolymerization can be conducted in one or more reactors. The polymerization product obtained is transferred to an evaporation tank, which can also be referred to as a degassing vessel, and volatile components such as residual monomers and organic solvents are separated off. The volatile components removed are condensed using coolers. In addition, a purification is performed in order to obtain the copolymer end product in maximum yield.

EP 3 689 923 B1 describes a process for preparing a polymer from an aromatic vinyl compound and a vinyl cyanide compound. A freshly added organic solvent is sprayed onto volatile components that have been separated off. Volatile components are separated from the product mixture containing polymer, residual monomers and organic solvent using an evaporation tank and by means of condensation of the volatile constituents that have been separated off in one or two series-connected condensers. Improved condensation can be achieved by increasing the pressure and reducing the cooling temperature.

The disadvantage of increasing the pressure is the associated undesirable rise in the proportion of volatile organic constituents remaining in the polymer.

Furthermore, EP 3 689 923 B1 details installation restrictions as limits in the lowering of the temperature of a coolant fed in in the condensation, which leads to discharge of uncondensed volatile components from the process. In addition, condensation efficiency is reduced when the amount of vinyl cyanide monomers with a low boiling point is increased.

Another disadvantage of the process described in the prior art is spraying of solvents, since there is a risk of accumulation of the additionally added solvent in the overall system. In that case, an appropriate portion of the condensate must be removed from the system and disposed of.

Uncondensed volatile constituents are discharged into the environment or atmosphere through a wastewater treatment system by using a water-driven liquid ring pump. The greater the amount of uncondensed volatile constituents can be reduced, the lower the complexity of wastewater treatment and/or the amount of emissions.

U.S. Pat. No. 4,555,384 discloses a process and an apparatus for continuous bulk polymerization of styrene monomers and alkenylnitrile monomers. Steam containing monomers is withdrawn directly from the polymerization reactor and fed to a condenser.

EP 3 689 919 A1 relates to the preparation of a polymer from an aromatic vinyl compound and a vinyl cyanide compound, wherein an evaporated portion of the reaction mixture is likewise conducted from the reactor into a condenser.

The object is to provide an energy-efficient and low-emission process and a corresponding apparatus in which, in particular, separation and disposal of condensed vapors and possibly wastewater can be avoided.

It is known that using a higher coolant temperature is more economical than the use of a lower coolant temperature. Therefore, it is desirable to condense as high a proportion of vapors as possible at a relatively high coolant temperature. If the process permits supply of coolant with a higher feed temperature in at least one condensation step, it is possible to use river water or a cooling water produced by cooling with river water. It is possible here to dispense with the provision of cooling water or brine by means of refrigeration systems.

A higher temperature of the coolant can be compensated for by a larger surface area for heat transfer. For this purpose, it is firstly possible to use larger heat exchangers or to achieve an improvement in, or replace, condensation efficiency by injecting evaporating liquids.

It is additionally possible by reducing the temperature to avoid blockage of the system by polymerization of the condensate obtained, particularly when it does not contain any inhibitor, since the polymerization is generally faster at higher temperature. Accordingly, a lower temperature in the system is advantageous with regard to blockage. This is achieved by recycling of the condensate and the associated early cooling of the vapor stream.

The invention relates to a process for preparing a copolymer proceeding from at least one aromatic vinyl compound, particularly styrene and/or alpha-methylstyrene, and at least one further monomer from the group consisting of acrylonitrile and methacrylate, wherein the process comprises the following steps:
a) polymerizing the at least one aromatic vinyl compound and the at least one further monomer in at least one reactor in the presence of at least one organic solvent, to obtain a polymerization product comprising copolymer, residual monomers, the at least one organic solvent and oligomers, if any,
b) separating volatile components from the polymerization product obtained in step a),
   wherein the separation is effected in a degassing vessel at a reduced pressure of 1 to 150 mbar absolute, particularly from 10 to 100 mbar absolute, and the polymerization product is heated in a first heat exchanger and the first heat exchanger is operated at a first media feed temperature of more than 200 °C, particularly within a range from 220 °C to 340 °C,
   to obtain a vapor stream comprising the volatile components,
c) condensing at least portions of the vapor stream obtained in step b), wherein the vapor stream is cooled in at least one second heat exchanger and a third heat exchanger, a first condensate exits from the second heat exchanger and a second condensate exits from the third heat exchanger,
   wherein the second heat exchanger is operated at a second media feed temperature within a range from 10 °C to 40 °C, particularly from 15 °C to 30 °C, and the third heat exchanger is operated at a third media feed temperature within a range from- 10 °C to 30 °C, particularly from −10 °C to 15 °C, and the second media feed temperature is at least 10 °C higher than the third media feed temperature, and
   wherein the first condensate and/or the second condensate are returned and contacted with the vapor stream, particularly injected into the vapor stream, at at least one site upstream of the second heat exchanger and/or at a further site in the third heat exchanger, and
d) optionally recycling the first condensate and/or the second condensate into the reactor of step a).

The invention also relates to an apparatus for performing the process of the invention, comprising a reactor, a first heat exchanger, a degassing vessel, optionally a column with a column top space, a second heat exchanger with a gas outlet and a liquid outlet, a third heat exchanger, wherein these are connected successively downstream in the sequence specified, the third heat exchanger has a feed space and a collection space and is preferably in a vertical arrangement, the liquid outlet of the second heat exchanger and/or the collection space of the third heat exchanger are connected to the feed space of the third heat exchanger via a first condensate conduit, the liquid outlet of the second heat exchanger and/or the collection space of the third heat exchanger are optionally connected to the column top space of the column via a second condensate conduit and the liquid outlet of the second heat exchanger and/or the collection space of the third heat exchanger are optionally connected via a third condensate conduit to a vapor conduit connecting the degassing vessel to the column.

The process of the invention, or the apparatus of the invention, allows the condensation of the vapor stream, i.e. of the volatile components from the polymerization product, to be performed more economically and with lower emissions. In addition, if the column is used, less monomers and solvent are discharged via the oligomers obtained by the condensation and separated off. The amount of discharged monomers and of solvent can be further reduced by at least partial recycling of the condensate.

The process of the invention comprises a multistage condensation. At least two heat exchangers, namely the second heat exchanger and the third heat exchanger, are used to condense the vapor stream. The third media feed temperature is preferably lower than the second media feed temperature. Accordingly, the second heat exchanger is preferably operated at a higher temperature than the third heat exchanger. In the downstream third heat exchanger, which is preferably operated with a lower coolant temperature than the second heat exchanger upstream thereof, only the volatile components still remaining in the vapor downstream of the second heat exchanger are condensed. The coolant at a lower temperature in particular is thus required in the third heat exchanger only for a portion of the volatile components. For the condensation of the portion of the volatile components that has already been condensed in the second heat exchanger, a coolant with a higher temperature is thus sufficient, which is energetically advantageous.

Recycling of the condensate improves the condensation effect, and so the proportion of vapors that can already be condensed in the second heat exchanger is increased.

It has been found that recycling of the condensate to assist the condensation of the volatile components at at least one site and/or the further site allows the additional supply of solvents to be dispensed with, so as to avoid accumulation of solvents in the overall system.

Recycling of the condensate, which in turn evaporates through contact with the hot volatile components, cools the volatile components even before the actual condensation is performed, such that the cooling capacity still to be provided by the heat exchangers is reduced and condensation efficiency is at the same time increased.

The at least one aromatic vinyl compound and the at least one further monomer are present in the at least one organic solvent in step a) and are polymerized in the at least one reactor so as to form the polymerization product. Continuous bulk polymerization or solvent polymerization preferably takes place in the at least one reactor. The polymerization product contains the copolymer, residual monomers, the at least one organic solvent and any oligomers. In order to separate volatile components from the polymerization product, the latter is fed to the degassing vessel via the first heat exchanger, in which the polymerization product is heated.

The media temperature refers to the temperature in the feed of the heating or cooling medium of the respective heat exchanger. In the first heat exchanger, the polymerization product is heated by a heating medium. The first second heat exchanger and the third heat exchanger serve for cooling, and each of these is supplied with a coolant.

In the first heat exchanger, the volatile components such as unconverted monomers, solvents or oligomers are preferably partly evaporated, and so the first heat exchanger can also be referred to as a partial evaporator. In the reactor, the polymerization product is preferably at a reactor temperature within a range from 105 °C to 180 °C, further preferably within a range from 105 °C to 125 °C or within a range from 140 °C to 180 °C. The polymerization product is preferably heated in the first heat exchanger to a temperature within a range from 180 °C to 270 °C.

The first heat exchanger is preferably disposed atop the degassing vessel, and particularly forms a construction unit together with the degassing vessel. Alternatively, the first heat exchanger may be in a separate arrangement from the degassing vessel. By means of a vacuum system, which is preferably disposed downstream of the degassing vessel, further preferably downstream of the third heat exchanger, there is preferably a reduced pressure in the system, in particular the degassing vessel, which is entered by the polymerization product including the volatile components from the first heat exchanger. The copolymer is separated here from the volatile components. A phase containing the copolymer, which forms the lower phase in the degassing vessel, is discharged. A gaseous phase, which contains the volatile components and is referred to as vapors or vapor stream, is discharged from the degassing vessel, in particular above the phase containing the copolymer. The vapor stream is in particular gaseous. The third media feed temperature in the third heat exchanger can be used to control the amount of gaseous vapors that reach the vacuum system.

The vapor stream preferably contains the aromatic vinyl compound, in particular aromatic vinyl monomer such as styrene and/or alpha-methylstyrene, the at least one further monomer, in particular vinyl cyanide monomer such as acrylonitrile, methacrylate monomer such as MMA, oligomers and/or organic solvent such as ethylbenzene, toluene and/or methyl ethyl ketone (MEK), and optionally water, in particular water vapor. A solution that is supplied to the first heat exchanger and from which the vapor stream is formed preferably contains 1 to 5000 ppm of water. The stream referred to in the context of the invention as vapor stream B is variable in terms of volume and composition as the process steps described are followed.

The copolymer prepared preferably comprises SAN copolymers, AMSAN copolymers and/or SMMA copolymers.

The vapor stream is condensed in multiple stages. The vapor stream is preferably first condensed in the second heat exchanger and then in the third heat exchanger. In the third heat exchanger, the vapor stream is cooled further, which also counteracts polymerization and hence blockage of the pipelines, and ideally complete condensation in particular is achieved.

Preferably, the vapor stream upstream of the second heat exchanger is guided through a separation unit, in particular a column, in which the vapor stream is contacted with the first condensate and/or the second condensate, with removal of oligomers from the vapor stream.

In a preferred embodiment, the second heat exchanger has a column connected upstream, which may have internals. The first condensate and/or the second condensate are preferably fed to the column in the upper portion, particularly at the top.

The bottom of the column is preferably heated, in particular to a temperature in a range from 150 °C to 280 °C. Oligomers that have been condensed out of the vapor stream are preferably collected at the bottom. The remaining vapor stream is preferably withdrawn at the top of the column and fed to the second heat exchanger. Liquid from the bottom of the column can be returned, in particular for further depletion of monomers and solvents, and in particular fed in at the first site together with the first condensate and/or the second condensate.

The wording “upstream of” with regard to the spatial arrangement of apparatuses is understood in the context of the present invention to mean that a first element such as a heat exchanger or a column is disposed upstream with respect to the conveying direction from a second element such as another heat exchanger, and so the vapor stream arrives first at the first element and then at the second element, for example goes from the column to the second heat exchanger.

In the second heat exchanger, a first condensate is formed, while the remaining gaseous vapor stream is fed into the third heat exchanger, where a second condensate is formed. The first condensate and/or the second condensate are returned at least to the third heat exchanger and additionally or alternatively, in particular additionally, further upstream of the second heat exchanger, and contacted with the vapor stream.

Preferably, in particular when the column is connected upstream of the second heat exchanger, the first condensate and/or the second condensate are recycled, particularly injected, into the column and/or into a vapor conduit between the degassing vessel and the column.

The reduced pressure is generated in the degassing vessel preferably by means of a vacuum system, which is particularly disposed downstream of the at least one further heat exchanger. The vacuum system is preferably designed as a liquid ring pump system and is further preferably operated with a liquid, wherein the liquid particularly comprises an organic mixture, preferably consists of the organic mixture, and the liquid particularly contains 10% to 90% by weight of the at least one aromatic vinyl compound, particularly styrene and/or alpha-methylstyrene, 5% to 50% by weight of the at least one further monomer and 0.5% to 50% by weight of the organic solvent, particularly ethylbenzene, based on the entirety of liquid in the vacuum system. Styrene and/or alpha-methylstyrene are preferably added to the liquid. The reduced pressure attainable via the liquid ring pump system, i.e. the minimum absolute pressure that can be attained, arises from the vapor pressure of the liquid used. The presence of styrene and/or alpha-methylstyrene in the liquid can, for example, lower the vapor pressure compared to acrylonitrile. The higher the content of styrene and/or alpha-methylstyrene in the liquid, the lower the attainable minimum absolute pressure.

In particular, the vacuum system has a liquid ring pump liquid circuit with liquid separator and overflow. The vacuum system preferably comprises the liquid ring pump system, a jet pump, the liquid ring pump liquid circuit with the liquid separator and the overflow, the fourth heat exchanger and the offgas heat exchanger.

The vacuum system is preferably fluidically connected to the collection space of the third heat exchanger. The vacuum system preferably comprises at least one pump designed as a liquid ring pump system, an overflow and a pump heat exchanger, and the pump heat exchanger is preferably disposed downstream on the high-pressure side of the pump and connected to the low-pressure side of the pump via a return conduit. There is preferably a feed conduit disposed between the overflow and the pump heat exchanger, and this is used to add the liquid from the vacuum system, in particular the liquid ring pump system.

The vacuum system is preferably disposed downstream of the third heat exchanger. The vacuum system supplies the reduced pressure particularly in the first heat exchanger, the degassing vessel, if necessary the column, the second heat exchanger and the third heat exchanger.

The reduced pressure is preferably generated in the degassing vessel by means of a vacuum system, which is particularly disposed downstream of the second heat exchanger and the third heat exchanger. The vacuum system preferably comprises at least one pump which is designed as a liquid ring pump system and is operated with a liquid which is separated by means of a liquid separator from an offgas withdrawn from the pump on the pressure side of the pump and fed to the pump.

The pump, which is also referred to as a vacuum pump, may have an upstream jet pump, also referred to as an ejector, in order to enable further lowering of the pressure in the plant section up to the degassing vessel.

Preferably, at least portions of the first condensate and/or the second condensate are fed to the liquid in the liquid ring pump system. Further preferably, the at least one aromatic vinyl compound A is added to the liquid.

Recycling the condensate that contains components of the vapor stream into the vapor stream can slightly reduce condensation efficiency compared to the addition of solvents to the vapor stream, according to EP 3 689 923B1, and hence increase the amount of uncondensed vapors at the inlet of the vacuum system. This can be compensated for by the use of a liquid containing at least the one aromatic vinyl compound in the liquid ring pump system. The uncondensed vapors can still be condensed in the vacuum system and returned to the reactor.

It is optionally possible to condense volatile components that have not been condensed in the liquid by means of an offgas heat exchanger of the vacuum system and return them to the reactor. The offgas heat exchanger is preferably operated at a higher pressure than the second heat exchanger and/or the third heat exchanger. In particular, the offgas heat exchanger is operated at a pressure of more than 900 mbar. Therefore, the condensation efficiency of the offgas heat exchanger is high, and so virtually no gaseous vapors escape into the offgas.

The liquid separator preferably has an overflow. Further preferably, liquid passing through the overflow is removed from the vacuum system and returned in particular to the reactor.

Preferably, a portion of the at least one aromatic vinyl compound is added to the liquid, wherein the at least one aromatic vinyl compound is present in particular in mixture with an inhibitor, and the amount of aromatic vinyl compound added to the liquid is at least 10% by weight, further preferably at least 20% by weight, of a gaseous portion of the vapor stream that is fed to the vacuum system.

The content of inhibitor, particularly dissolved in the at least one aromatic vinyl compound, is preferably 1 to 50 ppm, based on the mixture of aromatic vinyl compound and inhibitor in the vacuum system.

The liquid is preferably cooled in a pump heat exchanger, which is also referred to as the fourth heat exchanger. Further preferably, the portion of the at least one aromatic vinyl compound is added to the liquid upstream of the pump heat exchanger. The pump heat exchanger is preferably operated with a fourth media feed temperature T4. Further preferably, the fourth media feed temperature T4 is lower than the second media feed temperature T2 of the second heat exchanger. In particular, a difference between the second media feed temperature T2 and the fourth media feed temperature T4 is at least 10 °C.

The offgas of the vacuum system is preferably at least partly condensed in the offgas heat exchanger, which is also referred to as the fifth heat exchanger, further preferably at ambient pressure, in particular at a pressure of more than 900 mbar. The offgas heat exchanger is preferably operated with a fifth media feed temperature T5; further preferably, the fifth media feed temperature T5 is lower than the second media feed temperature T2 of the second heat exchanger. In particular, a difference between the second media feed temperature T2 and the fifth media feed temperature T5 is at least 10 °C. Because of the lower temperature in the offgas heat exchanger, components that left the second heat exchanger still in the gaseous state may yet be condensed downstream of the second heat exchanger. There is thus no need for all components to already have condensed in the second heat exchanger, and so the second heat exchanger can be operated with a warmer coolant, for example river water.

Preferably, the first condensate and/or the second condensate are contacted with the vapor stream in cocurrent at a first site upstream of the column, the first condensate and the second condensate are contacted with the vapor stream in countercurrent at a second site in the column, and/or the first condensate and/or the second condensate are contacted with the vapor stream in cocurrent at a third site in the third heat exchanger.

Recycling of the first condensate and/or the second condensate at the first site, particularly upstream of the column, results in cooling of the vapor stream before entry into the column, such that a lower level of deposits, i.e. a lower degree of polymerization, occurs in the column.

The feeding of the first condensate and/or the second condensate at the second site leads to further separation of oligomers out of the condensate.

The recycling of the first condensate and/or the second condensate at the third site serves in particular to cool condensate from the first buffer vessel.

The vapor stream is preferably cooled by the feeding of the first condensate and/or the second condensate at the first site, wherein the temperature difference in the vapor stream upstream and downstream of the first site is at least 25 °C and the vapor stream downstream of the first site is at a temperature of at least 120 °C.

Further, the vapor stream is preferably cooled by the feeding of the first condensate and/or the second condensate at the second site, wherein the vapor stream downstream of the second site is further preferably at a temperature within a range from 65 °C to 190 °C.

At least one buffer vessel, which can also be referred to as a storage vessel, may be disposed downstream of the second heat exchanger and/or the third heat exchanger. The first condensate and/or the second condensate are preferably collected in one or more buffer vessels, wherein water is optionally separated out, particularly from the first condensate and/or the second condensate, in at least one buffer vessel. At least one of the one or more buffer vessels preferably comprises a water separator.

The vapor stream on withdrawal from the degassing vessel preferably contains 10% to 90% by weight, particularly 25% to 65% by weight, of the at least one aromatic vinyl compound, particularly styrene, 5% to 60% by weight, particularly 10% to 40% by weight, of the at least one further monomer, particularly acrylonitrile, and 0.5% to 50% by weight, particularly 25% to 45% by weight, of the organic solvent, particularly ethylbenzene, toluene and/or MEK, based in each case on the overall vapor stream.

In addition, an inhibitor can be added. An inhibitor is preferably added to the first condensate and/or the second condensate, particularly upstream of the third heat exchanger. The inhibitor is preferably supplied to the third heat exchanger together with the first condensate and/or the second condensate. The inhibitor, particularly dissolved in the at least one aromatic vinyl compound, is preferably added in an amount of 1 to 20 ppm, based on the vapor stream withdrawn from the degassing vessel.

The inhibitor comprises or consists of preferably 4-tert-butylcatechol (TBC), alkoxyphe-nol such as 4-methoxyphenol (MEHQ) and/or thiophenol, particularly sterically hindered thiophenol, such as 4-hydroxy-2,2,6,6-tetramethylpiperidinyloxyl (4-hydroxy-TEMPO).

The sum total of the amounts of the first condensate and the second condensate that are returned at the at least one site and the further site, particularly at the first site, the second site and the third site, is preferably at least 50% by weight, based on the vapor stream withdrawn from the degassing vessel.

The first condensate and/or the second condensate are preferably fed in at the first site in a total amount of up to 40% by weight, based on the vapor stream withdrawn from the degassing vessel. In addition, the first condensate and/or the second condensate are preferably fed to the column, particularly at the second site, in a total amount of up to 150% by weight, based on the vapor stream withdrawn from the degassing vessel. In the case of recycling of more than 100% by weight, the condensate is recirculated repeatedly.

The first condensate and/or the second condensate are preferably injected into a vapor conduit at the at least one site, particularly upstream of the column.

The first heat exchanger, the second heat exchanger and the third heat exchanger are preferably designed as a shell and tube heat exchanger. The first heat exchanger is preferably in a vertical arrangement. The second heat exchanger is preferably in a horizontal arrangement. The third heat exchanger is preferably in a vertical arrangement.

A vertical arrangement means that, in the direction of gravity, first a feed space is then followed by a heat exchange surface, particularly a bundle of tubes, and then by a collection space. The feed space is preferably a top space and the collection space is preferably a bottom space. In particular, tubes of the first heat exchanger and/or the third heat exchanger are aligned in the direction of gravity. In a horizontal arrangement, the tubes, particularly of the second heat exchanger, are arranged perpendicular to the direction of gravity.

The first condensate and/or the second condensate are preferably injected into the top space of the third heat exchanger, particularly in the flow direction of the vapor stream.

The medium used in the second heat exchanger is preferably water. The medium used in the third heat exchanger is preferably brine and/or water containing glycol. The medium in the second heat exchanger and in the third heat exchanger is preferably a cooling medium. The second heat exchanger is preferably operated with river water or a coolant which is provided by cooling with river water. The river water is preferably used in a secondary circuit.

The medium in the first heat exchanger is particularly a heating medium. The medium used in the first heat exchanger is preferably Diphyl vapor such as Therminol VP1 or a heating liquid, particularly a heating oil. The heating oil is preferably selected from mineral oils or synthetic oils which are known to the skilled person, for example, as Therminol T66, T62, T55, T72 or Melatherm SH.

### BRIEF DESCRIPTION OF THE DRAWINGS

Working examples of the invention are shown in the drawings and are elucidated in detail in the description that follows.

The figures show:

FIG. 1 a schematic diagram of a first embodiment of the invention,

FIG. 2 a schematic diagram of a second embodiment of the invention and

FIG. 3 a schematic diagram of a third embodiment of the invention.

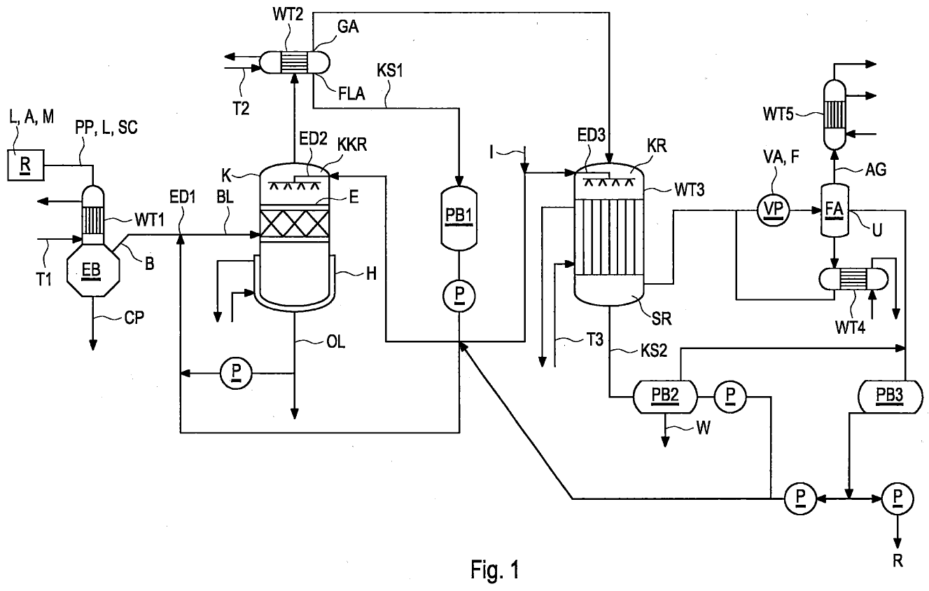

FIG. 1 shows a schematic diagram of a first embodiment of the invention.

An aromatic vinyl compound A, at least one further monomer M and an organic solvent L are added to a reactor R. In the reactor R, a polymerization product PP is formed, which comprises a copolymer CP and the organic solvent L.

The polymerization product PP is first fed to a first heat exchanger WT1, where the polymerization product PP is heated with a heating medium at a first media feed temperature T1. The heated polymerization product PP is transferred from the first heat exchanger WT1 into a degassing vessel EB, from which firstly the copolymer CP and secondly a gaseous vapor stream B containing volatile components are withdrawn.

The vapor stream B is fed from the degassing vessel EB via a vapor conduit BL into a column K having a column top space KKR and having internals E. Oligomers OL are withdrawn from the bottom of the column K, which is heated with a heating jacket H. From the top of the column K, the remaining vapor stream B is transferred onward into a second heat exchanger WT2, where the vapor stream B is partly condensed with a coolant having a second media feed temperature T2, so that a first condensate KS1 is withdrawn from the second heat exchanger WT2 at a liquid outlet FLA. The first condensate KS1 is intermediately stored in a first buffer vessel PB1.

The gaseous vapor stream B still remaining is passed from the second heat exchanger WT2 from a gas outlet GA into a third heat exchanger WT3, where it is further condensed by means of a further coolant with a third media feed temperature T3. The second heat exchanger WT2 is in a horizontal arrangement, while the third heat exchanger WT3 is in a vertical arrangement. A second condensate KS2 is withdrawn from a bottom space SR in the third heat exchanger WT3 and fed to a second buffer vessel PB2. Water W is separated out in the second buffer vessel PB2. The second buffer vessel PB2 is filled hydraulically; an upper phase flows via the top of the second buffer vessel PB2 into a third buffer vessel PB3.

A vacuum system VA is also connected to the bottom space SR of the third heat exchanger WT3 and is operated with a liquid F and comprises a vacuum pump VP and a liquid separator FA with an overflow U. The vacuum pump VP is designed as a liquid ring pump. The liquid F is cooled in a fourth heat exchanger WT4. An offgas AG from the vacuum system VA is condensed in a fifth heat exchanger WT5 in order to reduce gaseous emissions from the process. Buffers are stored in the third buffer vessel PB3 to compensate for fluctuations in throughput.

The first condensate KS1 from the heat exchanger WT2 is injected into the vapor stream B at a first site ED1 in the vapor conduit BL upstream of the column K. By evaporating the first condensate KS1 at the first site ED1, the vapor stream B is already cooled before it enters the column K.

In addition, the first condensate KS1 from the second heat exchanger WT2 is introduced into the top of the column K at a second site ED2 and contacted there with the vapor stream B to separate the oligomers OL.

In addition, the first condensate KS1 is injected at a third site ED3 in a top space KR of the third heat exchanger WT3 in order to further cool the vapor stream B and to obtain the second condensate KS2.

The second condensate KS2 and the mixture from the third buffer vessel PB3 can be partly added to the first condensate KS1 for recycling at the first site ED1, the second site ED2 or the third site ED3. In addition, the mixture collected in the third buffer vessel PB3 is returned to the reactor R by a pump and, if necessary, by a further buffer vessel in order to convert remaining unconverted monomers to the copolymer CP. Pumps P are used to convey the condensates KS1, KS2.

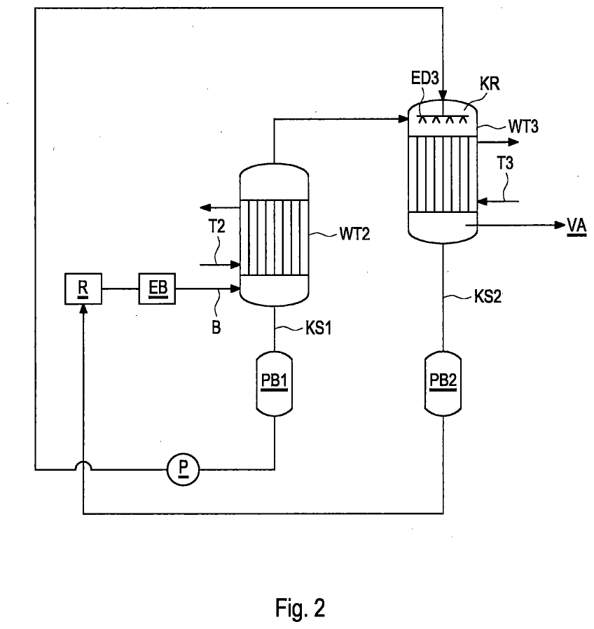

FIG. 2 shows a schematic of a second embodiment of the invention.

In the illustrative second embodiment, by contrast with the first embodiment, the vapor stream B is supplied directly from the degassing vessel EB to the second heat exchanger WT2, and so there is no column K here. The first condensate KS1 is injected from the second heat exchanger WT2 into the top space KR of the third heat exchanger WT3 in order to cool the condensate as far as possible, and the second condensate KS2 is, if necessary, returned to the reactor R via a further buffer vessel. Inhibitor can be added in the case of recycling into the third heat exchanger WT3.

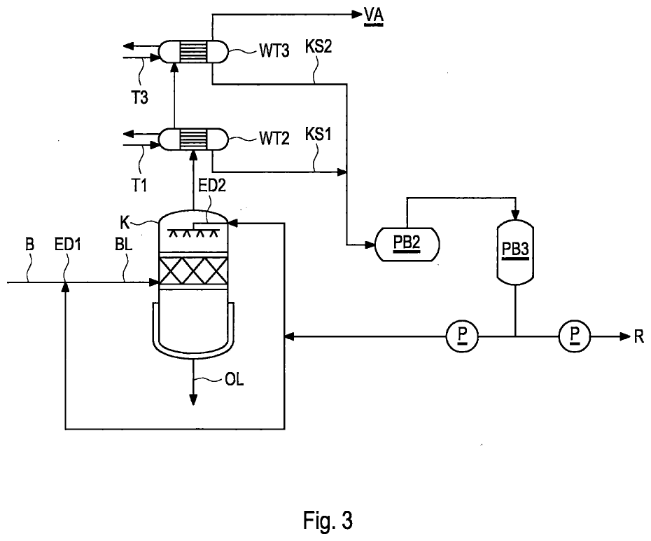

FIG. 3 shows a schematic diagram of a third embodiment of the invention. The vapor stream B is fed to the second heat exchanger WT2 via a column K and conducted from the second heat exchanger WT2 onward into a third heat exchanger WT3. The second heat exchanger WT2 and the third heat exchanger WT3 are in a horizontal arrangement in this illustrative embodiment.

The first condensate KS1 from the second heat exchanger WT2 and the second condensate KS2 from the third heat exchanger WT3 are mixed in a second buffer vessel PB2 and fed in partly at a first site ED1 into the vapor stream B in the vapor conduit BL upstream of the column K and at a second site ED2 at the top of the column K. The warmer first condensate KS1 is mixed with the cold second condensate KS2 in the second buffer vessel PB2.

The invention is not limited to the working examples described herein. Instead, a multitude of modifications are possible within the scope specified by the claims.

### EXAMPLES

The process was conducted as per the first embodiment according to FIG. 1, with pro-duction of an SAN copolymer.

A total flow rate of 4.3 t/h was fed into the reactor. Firstly 2.47 t/h of copolymer and secondly 1.83 t/h of vapor were withdrawn from the degassing vessel. The polymer contained 1.6 to 2 t/h of styrene and 0.47 to 0.87 t/h of acrylonitrile. A polymer containing 65% by weight of styrene and 35% by weight of acrylonitrile was produced in each case.

### Example 1

The vapor stream was withdrawn from the degassing vessel at a temperature of 260 °C. Upstream of the column, the vapor stream was contacted with 200 l/h of the first condensate, with injection of the mixture into the vapor conduit so that the feed stream into the column had an overall temperature of 225 °C. The bottom of the column K was at a controlled temperature of 250 °C.

At the top of the column, 2.2 t/h of the first condensate were fed in. Accordingly, there was a recycling rate of 120% at that feed point.

The pressure at the top of the column was 53 mbar. The vapor stream was withdrawn from the top of the column at a temperature of 160 °C and fed to the second heat exchanger, where it was partly condensed with a coolant at a second media feed temperature T2 of 19 to 25 °C. On departure from the second heat exchanger, the second media temperature was 30 °C. 2.86 t/h of first condensate were withdrawn from the second heat exchanger, and the remaining vapor stream was fed to the third heat exchanger at a temperature of 30 °C. The first condensate was at a temperature of 47 °C.

At the third site, 0.46 t/h of the first condensate was sprayed into the top space of the third heat exchanger. The third media feed temperature in the third heat exchanger was 7 °C.

Downstream of the third heat exchanger, 0.85 t/h of styrene was fed in and the mixture was returned to the reactor.

The fourth heat exchanger WT4 and the fifth heat exchanger WT5 were operated at a coolant feed temperature of 7 °C. Only traces of monomers or solvent were detectable in the offgas from the fifth heat exchanger WT5. There was no wastewater to be disposed of.

### Example 2

On the basis of the embodiment according to FIG. 3, a further exemplary embodiment is described hereinafter, with injection of about 500 kg/h of the mixture of first and second condensate into the vapor conduit at the first site, with a recycling rate here of about 95%. This led to a temperature of 158 °C in the overall stream at the inlet into the column. The bottom of the column was at a controlled temperature of 162 °C. 400 kg/h of the mixture of first condensate and second condensate were fed into the top space of the column. The vapor stream leaving the column at the top was at a temperature of 79.5 °C. The second media temperature on departure from the second heat exchanger was 24 °C, and so the remaining vapor stream was at a temperature of 35 °C and was directed into the third heat exchanger.

In the third heat exchanger, the third media feed temperature T3 was 1.5 °C, which resulted in a temperature of the gas stream leaving the third heat exchanger WT3 of 21 °C.

In this example too, there was no wastewater that had to be sent to wastewater treatment. Only traces of monomers or solvent were detectable in the offgas from the vacuum pump.

While virtually complete recovery of all monomers and solvent was achieved in example 1 by means of multiple addition sites for condensate, and neither wastewater nor significant contamination in the offgas was observed, this was achieved in example 2 by a much more significant lowering of the vapor temperature upstream of the second heat exchanger WT2.

### Comparative Example 1

The process was conducted in essentially the same way as example 1, except that, rather than the first condensate, the vapor stream was contacted upstream of the column with 200 l/h of ethylbenzene as organic solvent L. This led to an increase in the level in the buffer vessel upstream of the reactor, and so about 6 t of the mixture had to be separated off and disposed of after 12 hours.

### LIST OF REFERENCE SIGNS

CP copolymer
A aromatic vinyl compound
M further monomer
R reactor
L organic solvent
PP polymerization product
EB degassing vessel
T1 first media feed temperature
B vapor stream
BL vapor conduit
WT1 first heat exchanger
WT2 second heat exchanger
WT3 third heat exchanger
WT4 fourth heat exchanger
WT5 fifth heat exchanger
GA gas outlet
FLA liquid outlet
KS1 first condensate
KS2 second condensate
T2 second media feed temperature
T3 third media feed temperature
ED1 first site
ED2 second site
ED3 third site
I inhibitor
VA vacuum system
F liquid
FA liquid separator
U overflow
PB1 first buffer vessel
PB2 second buffer vessel
PB3 third buffer vessel
P pump
E internals
H heating jacket
K column
OL oligomers
SR bottom space
W water
VP vacuum pump
AG offgas
KR top space

1-17. (canceled)

18. A process for preparing a copolymer (CP) from at least one aromatic vinyl compound (A) and at least one further monomer (M) selected from the group consisting of acrylonitrile and methacrylate, wherein the process comprises the following steps:
a) polymerizing the at least one aromatic vinyl compound (A) and the at least one further monomer (M) in at least one reactor (R) in the presence of at least one organic solvent (L) to obtain a polymerization product (PP) comprising the copolymer (CP), residual monomers, the at least one organic solvent (L), and oligomers, if any;
b) separating volatile components from the polymerization product (PP) obtained in step a),
wherein the separation is effected in a degassing vessel (EB) at a reduced pressure ranging from 1 to 150 mbar absolute, and
wherein the polymerization product (PP) is heated in a first heat exchanger (WT1) configured to operate at a first media feed temperature (T1) of more than 200 °C to obtain a vapor stream (B) comprising the volatile components;
c) condensing at least one portion of the vapor stream (B) obtained in step b),
wherein the vapor stream (B) is cooled in at least one second heat exchanger (WT2) and a third heat exchanger (WT3),
wherein a first condensate (KS1) exits from the at least one second heat exchanger (WT2) and a second condensate (KS2) exits from the third heat exchanger (WT3),
wherein the at least one second heat exchanger (WT2) is operated at a second media feed temperature (T2) ranging from 10 °C to 40 °C and the third heat exchanger (WT3) is operated at a third media feed temperature (T3) ranging from −10 °C to 30 °C,
wherein the second media feed temperature (T2) is at least 10 °C higher than the third media feed temperature (T3), and
wherein the first condensate (KS1) and/or the second condensate (KS2) are returned and contacted with the vapor stream (B), at at least one site (ED1, ED2) upstream of the at least one second heat exchanger (WT2) and/or at a further site (ED3) in the third heat exchanger (WT3); and
d) optionally recycling the first condensate (KS1) and/or the second condensate (KS2) into the reactor (R) of step a).

19. The process of claim 18, wherein the at least one aromatic vinyl compound (A) is styrene and/or alpha-methylstyrene.

20. The process of claim 18, wherein the vapor stream (B), upstream of the at least one second heat exchanger (WT2), is conducted through a separation unit, in which the vapor stream (B) is contacted with the first condensate (KS1) and/or the second condensate (KS2) to remove oligomers from the vapor stream (B).

21. The process of claim 20,
wherein the first condensate (KS1) and/or the second condensate (KS2) are contacted with the vapor stream (B) in cocurrent at a first site (ED1) upstream of a column (K),
wherein the first condensate (KS1) and/or the second condensate (KS2) are contacted with the vapor stream (B) in countercurrent at a second site (ED2) in the column (K), and/or
wherein the first condensate (KS1) and/or the second condensate (KS2) are contacted with the vapor stream (B) in cocurrent at a third site (ED3) in the third heat exchanger (WT3).

22. The process of claim 20,
wherein the vapor stream (B) is cooled by the feeding of the first condensate (KS1) and/or the second condensate (KS2) at the first site (ED1), and the temperature difference in the vapor stream (B) upstream of the first site (ED1) and downstream of the first site (ED1) is at least 25 °C, and wherein the vapor stream (B) downstream of the first site (ED1) is at a temperature of at least 120 °C, and/or
wherein the vapor stream (B) is cooled by the feeding of the first condensate (KS1) and/or the second condensate (KS2) at the second site (ED2), and wherein the vapor stream (B) downstream of the second site (ED2) is at a temperature ranging from 65 °C to 190 °C.

23. The process of claim 18,
wherein the first condensate (KS1) and/or the second condensate (KS2) are collected in one or more buffer vessels (PB1, PB2), and
wherein water is optionally separated out in at least one of the one or more buffer vessels (PB1, PB2).

24. The process of claim 18, wherein the vapor stream (B) on removal from the degassing vessel (EB) contains:
10% to 90% by weight of the at least one aromatic vinyl compound (A);
5% to 60% by weight of the at least one additional monomer (M); and
0.5% to 50% by weight of the at least one organic solvent (L),
based on the total weight of the vapor stream (B).

25. The process of claim 18, wherein the at least one organic solvent (L) is ethylbenzene.

26. The process of claim 18, wherein an inhibitor (I) is added to the first condensate (KS1) and/or the second condensate (KS2) upstream of the third heat exchanger (WT3).

27. The process of claim 26, wherein the inhibitor (I) is added in an amount ranging from 1 to 20 ppm, based on the vapor stream (B) withdrawn from the degassing vessel (EB).

28. The process of claim 27, wherein the inhibitor (I) is dissolved in the at least one aromatic vinyl compound (A).

29. The process of claim 21,
wherein the first condensate (KS1) and/or the second condensate (KS2) are fed in at the first site (ED1) in a total amount of up to 40% by weight, based on the total weight of the vapor stream (B) withdrawn from the degassing vessel (EB), and/or
wherein the first condensate (KS1) and/or the second condensate (KS2) are fed to the column (K), in a total amount of up to 150% by weight, based on the total weight of the vapor stream (B) withdrawn from the degassing vessel (EB).

30. The process of claim 29, wherein the first condensate (KS1) and/or the second condensate (KS2) are fed to the column (K) at the second site (ED2).

31. The process of claim 21, wherein the first condensate (KS1) and/or the second condensate (KS2) are injected into a vapor conduit at the at least one site (ED1) upstream of the column (K).

32. The process of claim 21, wherein the first condensate (KS1) and/or the second condensate (KS2) are fed in at the top of the column (K).

33. The process of claim 18, wherein the first condensate (KS1) and/or the second condensate (KS2) are fed in at the further site (ED3) in the third heat exchanger (WT3) in a total amount of up to 150% by weight, based on the total weight of the vapor stream (B) withdrawn from the degassing vessel (EB).

34. The process of claim 18, wherein the third heat exchanger (WT3) is in a vertical arrangement.

35. The process of claim 34, wherein the first condensate (KS1) and/or the second condensate (KS2) are fed into a feed space of the third heat exchanger (WT3).

36. The process of claim 18, wherein the sum total of the amounts of the first condensate (KS1) and the second condensate (KS2) that are returned at the at least one site (ED1, ED2) and the further site (ED3), is at least 50% by weight, based on the total weight of the vapor stream (B) withdrawn from the degassing vessel (EB).

37. The process of claim 18, wherein the at least one second heat exchanger (WT2) is operated with river water or a coolant which is provided by cooling with river water.

38. The process of claim 18,
wherein the reduced pressure in the degassing vessel (EB) is generated by means of a vacuum system (VA);
wherein the vacuum system is designed as a liquid ring pump system operated with a liquid (F), and
wherein the liquid (F) comprises an organic mixture.

39. The process of claim 38, wherein the vacuum system (VA) is disposed downstream of the at least one second heat exchanger and the third heat exchanger (WT2, WT3).

40. The process of claim 38, wherein the liquid (F) contains:
10% to 90% by weight of the at least one aromatic vinyl compound (A);
5% to 50% by weight of the at least one additional monomer (M); and
0.5 to 50% by weight of the organic solvent (L),
based on the total weight of the liquid (F) in the vacuum system (VA).

41. An apparatus for performing the process of claim 18, comprising:
at least one reactor;
a first heat exchanger (WT1);
a degassing vessel (EB);
optionally a column (K) with a column top space (KKR);
a second heat exchanger (WT2) with a gas outlet (GA) and a liquid outlet (FLA); and
a third heat exchanger (WT3) with a feed space and a collection space,
wherein the at least one reactor, the first heat exchanger (WT1), the degassing vessel (EB), optionally the column (K), the second heat exchanger (WT2), and the third heat exchanger (WT3) are connected successively downstream in the sequence listed,
wherein the liquid outlet of the second heat exchanger (WT2) and/or the collection space of the third heat exchanger (WT3) are connected to the feed space of the third heat exchanger (WT3) via a first condensate conduit,
wherein the liquid outlet of the second heat exchanger (WT2) and/or the collection space of the third heat exchanger (WT3) are optionally connected to the column top space (KKR) of the column (K) via a second condensate conduit, and
wherein the liquid outlet of the second heat exchanger (WT2) and/or the collection space of the third heat exchanger (WT3) are optionally connected via a third condensate conduit to a vapor conduit connecting the degassing vessel (EB) to the column (K).

42. The apparatus of claim 41, wherein the third heat exchanger (WT3) is in a vertical arrangement.
